(19) United States
(12) Patent Application Publication
(10) Pub. No.: US 2007/0062759 A1
(43) Pub. Date: Mar. 22, 2007

(54) Safety line anchor

(76) Inventors: Karl Jones, Wiltshire (GB); Timothy George Bissett, Wiltshire (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/561,645

(22) PCT Filed: Jun. 23, 2004
(86) PCT No.: PCT/GB04/02710

§ 371 Date: Apr. 19, 2006

(30) Foreign Application Priority Data
Jun. 27, 2003 (GB) 0315104.0

(51) Int. Cl. A62B 35/00

(52) U.S. Cl. 182/3

(57) ABSTRACT

A bottom anchor assembly for a substantially vertically-orientated elongate safety line comprises safety line gripping means, tensioning mean for adjusting the safety line tension to a predetermined value, bracket means and connector arm means. The tensioning means and safety line gripping means are spaced apart and are linked by the connector arm means so that a safety line traveller moving along a safety line gripped by the safety line gripping means can pass over the safety line gripping means and the connector arm means.

The present invention relates to height safety equipment and, in particular, to an anchoring arrangement suitable for anchoring the lower end of an installation of a flexible elongate safety line disposed in a substantially vertical orientation on a tall structure.

Tall structures such as electricity pylons and radio or satellite communication masts are periodically inspected to determine whether any maintenance work is required. These structures are purposely built to be low maintenance and, because many of them stand in remote locations, they may require inspection only once every ten years, perhaps longer.

Also, in the interests of public safety, such structures are constructed to discourage easy ascent by non-authorised personnel. Hence, the lower leg portions of metal towers of this type are usually plain metal to a height of at least three metres from ground level, with no foot- or hand-holds. In fact, if such structures were built with access-ways or the like, the access-ways themselves would require periodic inspection for compliance with safety regulations. The interval between routine safety inspections is shorter than the required interval between routine maintenance inspections, so it would significantly increase the frequency of inspection for any kind of permanent access-way to form part of the tall structure.

Traditionally, personnel who have carried out maintenance inspections on metal towers, pylons, or the like have used rope-access techniques for ascent and making themselves fast at the top. In an effort to minimise some of the hazards associated with such work, the present applicants have devised a fall arrest system that can be installed on a tall structure.

The above-mentioned fall arrest system included a new bottom anchor assembly for securing a substantially vertically-oriented safety line to the lower portion of a tall structure which is described in European patent number EP 1054708B.

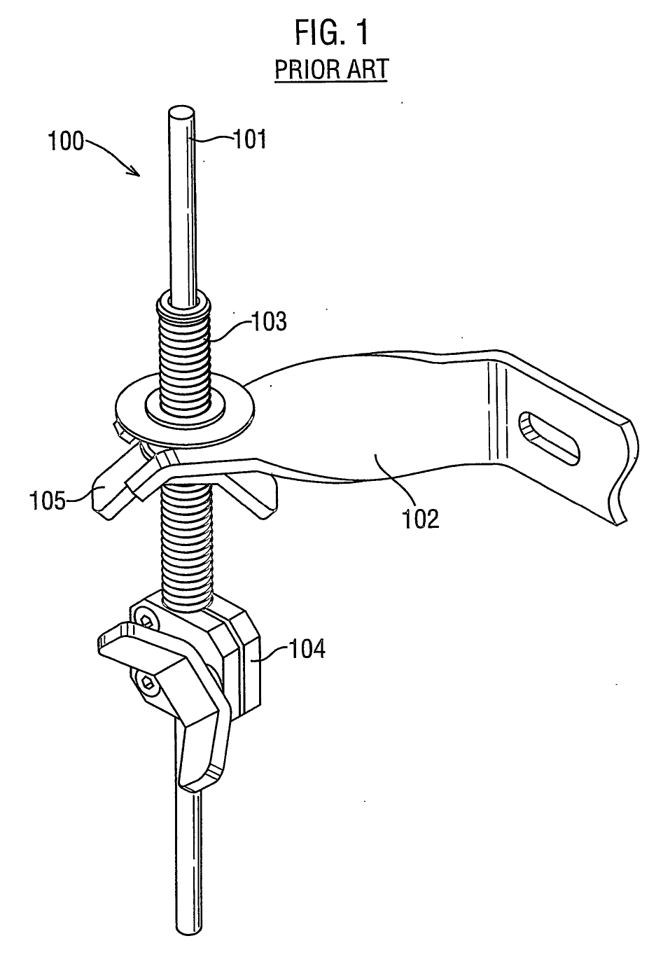

One example of this known bottom anchor assembly is shown in FIG. 1. The bottom anchor assembly 100 secures the lower end of a safety line 101 and tensions the cable. The bottom anchor assembly 100 is attached to the tall structure (not shown) through a bracket 102. The bottom anchor assembly 100 includes an externally screw threaded hollow shaft 103 through which the safety line 101 passes. A clamp 104 attached to the lower end of the tube clamps the safety line 101 and prevents it moving relative to the tube. A nut 105 engaged with the externally screw threaded tube 103 bears against the lower surface of the bracket 102 so that the safety line 101 can be tensioned to a desired level by rotating the nut 105 to move the tube 103 upwardly or downwardly relative to the bracket 102.

Although this safety line anchor arrangement has proved successful a difficulty has been encountered in use.

As noted above tall structures of the type which the safety anchor is commonly used with are usually designed to present a plain smooth metal surface providing no foot- or hand-holds to a height of a least three metres from ground level. As a result, the bracket used to attach the safety line bottom anchor must be located three metres or more above the ground in order to prevent it being used as a hand- or foot-hold to climb the structure. This location of the bracket out of reach of the ground is also advantageous to prevent accidental or malicious damage to the bracket and other parts of the fall arrest system.

This location of the bracket, three metres or more above ground level, results in the difficulty that personnel located below the bracket cannot be protected by the fall arrest system. As a result there is a problem that it is necessary to either provide a separate fall arrest system to protect personnel located between the bracket and ground level, or to leave personnel unprotected in this region. The additional cost of providing such an additional fall arrest system is self evident, as is the inconvenience of having to transport the components of such an additional fall arrest system between locations at which the fall arrest system is to be used. Another difficulty is that in practice many personnel will commonly regard attaching themselves to a fall arrest system and then detaching themselves from it purely to travel the relatively short distance between the bracket and the ground as too much trouble for the short distance involved. Such non-use of the additional fall arrest system will result in unacceptable health and safety risks, as of course will not providing an additional fall arrest system and leaving personnel unprotected.

The present invention was made in order to overcome these problems, at least in part.

In a first aspect, this invention provides a bottom anchor assembly for a substantially vertically-orientated elongate safety line, the anchor assembly comprising safety line gripping means, tensioning means for adjusting the safety line tension to a predetermined value, bracket means and connector arm means in which the tensioning means and safety line gripping means are spaced apart and are linked by the connector arm means.

Preferably, the safety line gripping means and the connector arm means are arranged to allow a safety line traveller moving along the safety line gripped by the safety line gripping means pass over the safety line gripping means and the connecting arm means.

Preferred embodiments of the invention will now be described by way of example only with reference to the accompanying diagrammatic figures, in which:

FIG. 1 shows a known bottom anchor assembly.

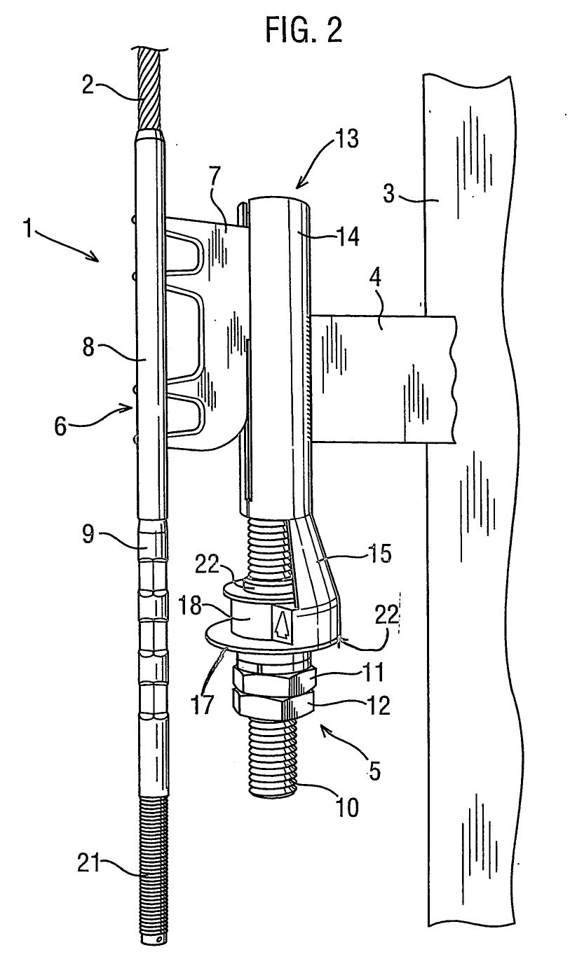

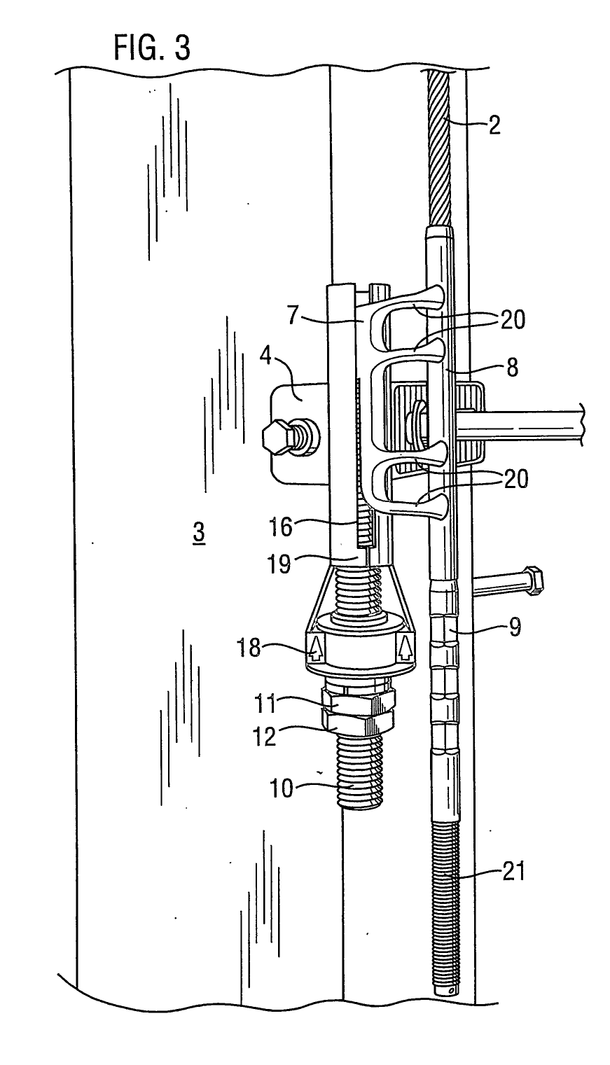

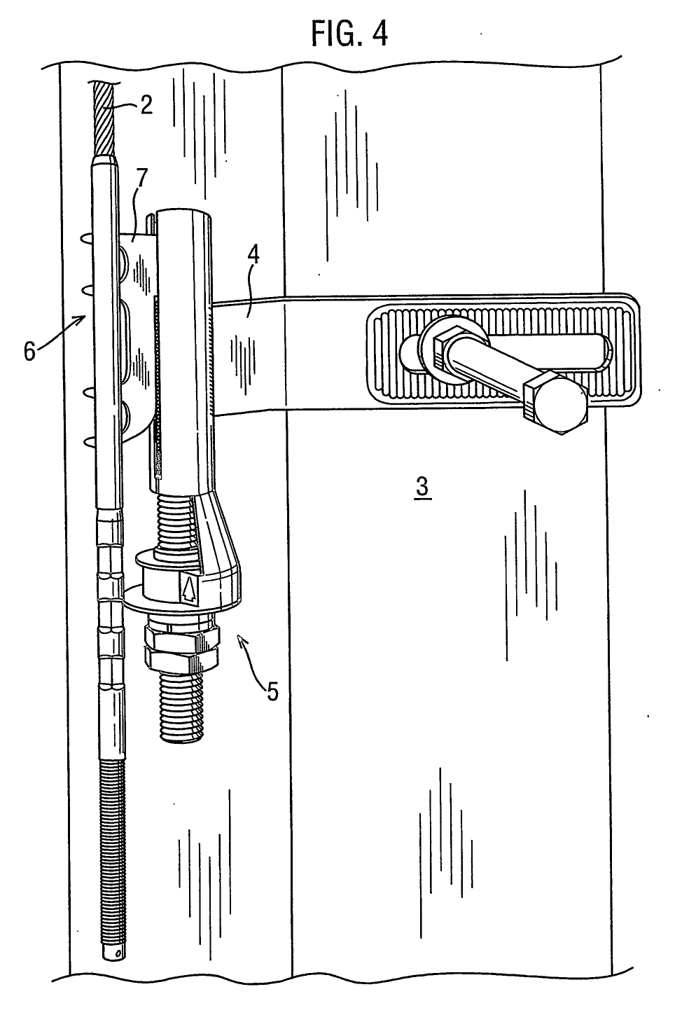

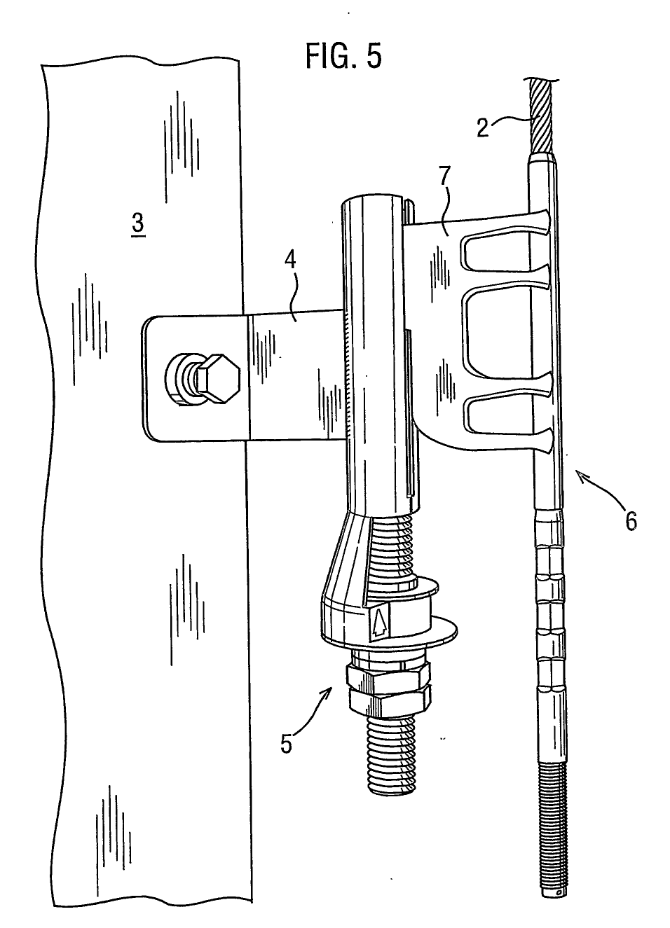

FIGS. 2 to 5 are different perspective views of an embodiment of the invention.

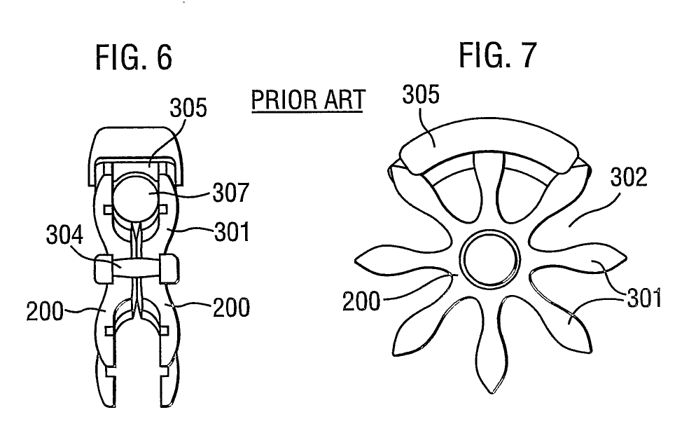

FIGS. 6 and 7 are explanatory diagrams showing a “star wheel” type safety line traveller.

A bottom anchor assembly 1 according to the invention is shown in FIGS. 2 to 5. In FIGS. 2 to 5 the fall arrest system 1 is shown attached to a safety line 2 in the form of a multi-stranded metal cable and attached to a fixed structure 3 by a bracket 4.

Typically the fixed structure 3 will be a tall structure such as an electricity pylon or radio or satellite communication mast but the invention is applicable to any structure requiring protection for workers or other personnel with a height safety or fall arrest system.

The bottom anchor assembly 1 comprises a tension setting section 5 and a cable securing section 6 linked by a support arm section 7.

The cable securing section 6 comprises a hollow cylindrical tube 8 having a central bore through which the safety line 2 passes Immediately below the tube 8 a swaged element 9 is secured to the end of the safety line 2. The swaged element 9 has a larger diameter than the internal bore of the tube 8 so that the swaged element 9 limits upward movement of the safety line 2 through the tube 8 and thus relative to the bottom anchor assembly 1.

The tension adjusting section 5 comprises a tubular externally screw threaded rod 10. The rod 10 is rigidly connected to the tube 8 of the cable securing section 6 by the support arm section 7.

A nut 11 is located on the rigid rod 10 engaged with the external screw thread.

The bracket 4 and the tension adjusting section 5 are arranged so that upward movement of the rod 10 relative to, the bracket 4 is prevented by the nut 11. As a result, when the bottom anchor assembly 1 is in use and the upper end of the safety line 2 is attached to another part of the fixed structure 3 the bottom end of the safety line 2 is held in place by the bottom anchor assembly 1 and the amount of static tension, applied to the safety line 2 can be controlled by rotation of the nut 11 about the rod 10. Such relative rotation of the nut 11 about the rod 10 will move the rod 10 and the attached support arm section 7 and cable securing section 6 relative to the bracket 4, so increasing or decreasing the tension in the safety line 2.

A locknut 12 is also provided on the rod 10 engaged with the external screw thread adjacent to the nut 11. When the nut 11 has been adjusted to apply the desired tension to the safety line 2 the locknut 12 can be tightened up against the nut 11 to releasably lock the nut 11 in place on the rod 10 and ensure that the tension in the safety line 2 remains constant.

The bracket 4 has a tension setting section receiving assembly 13 comprising an upper tubular section 14 and a lower tapering section 15. Preferably the tubular section 14 and tapered section 15 are integrally formed, but this is not essential.

The tubular section 14 is in the form of a split circular tube split by a single slot 16. The tapered section 15 ends in a downwardly facing load bearing surface 22. A thrust washer 17 is mounted on the rod 10 between the nut 11 and the load bearing surface of the tapered section 15 to provide a load path between the nut 11 and the bracket 4 in order to allow the movement of the bottom anchor assembly 1 relative to the bracket 4 and the tension of the safety line 2 to be controlled by rotation of the nut 11 about the rod 10.

A tension indicating unit 18 is located around the rod 10 in the load path between the nut 11 and the thrust washer 17 to provide an indication to the user when the tension in the safety line 2 is at a desired value.

The tapered shape of the taper section 15 and the cutting away of the taper section 16 so that it only extends in a semicircle in the illustrated embodiment is required in order to allow sufficient room for the tension indicator 18 and to allow the tension indicator 18 to be clearly seen. There would be no requirement for either of these features of the taper section 15 or the taper section 15 at all if an alternative form or location of tension indicator were used or the tension indicator were omitted. In this case the load bearing surface of the receiver assembly 13 could simply be formed by the bottom surface of the tubular section 14.

The tubular section 14 has an inner diameter slightly larger than the external diameter of the threaded rod 10 so that the rod 10 is able to move freely vertically within the tubular section 14 and the slot 16 is arranged to be parallel sided with a width slightly larger than the width of the part of the support arm 7 which passes through the slot 16 for most of its length. The tubular section 13 guides the vertical movement of the rod 10 and support arm 7 and prevents horizontal movement of the rod 10 and support arm 7 when the bottom anchor assembly 1 is subjected to side loads along the safety line 2. Such side loads can occur due to wind loading on the safety line 2 and will usually occur when a fall arrest event occurs. It will be understood that although the safety line 2 is usually arranged close to vertical it will usually not be precisely vertical, for example it may follow the profile of a part of the fixed structure 3 such as a pylon leg. Further, falls commonly involve some sideways component of movement as well as vertical movement due to gravity. As a result, it is usual for fall arrest events to result in large side loads along the safety line 2 to the bottom anchor assembly 1.

Although it is desirable to have small clearances between the rod 10 and support arm 7 and the cylindrical interior surface of the tubular section 14 and the sides of slot 16 the clearances should be sufficiently large to allow free vertical movement of the rod 10 and support arm 7 relative to the receiver assembly 13 and any interference fit between these parts should be avoided. Any such interference fit would result in large and unpredictable frictional loads which would make it difficult to accurately set and control the tension applied to the safety line 2.

As can be seen in FIGS. 2 to 5, towards the bottom end of the tubular section 13 the slot 16 is narrowed to form a narrow section 19 adjacent to the bottom end of the tubular section 14.

It is not essential that this narrow section 19 be provided but this is convenient in use of the bottom anchor assembly 1. When the bottom anchor assembly 1 is to be attached to the bracket 4 this can most conveniently be done by passing the rod 10 without the nut 11, locknut 12, thrust washer 17 and tension indicator 18 into the tubular section 14 from above. The rod 10 and attached support arm 7 and cable securing section 6 will then rest in place on the bracket 4 with the support arm 7 resting on the top of the narrowed section 19. The safety line 2 can then be passed through the tube 8 and the swaged element 9 attached and the tension indicator 18, thrust washer 17, nut 11 and locknut 12 are threaded onto the rod 10. If the narrow section 19 is not present it will be necessary to hold the rod 10 in place while the safety line 2 is threaded through the tube 8 and the swaged element 9 attached in order to prevent the rod 10 falling out of the bracket 4.

It is convenient for manufacturing for the slot 16 to extend along the full length of the tubular section 14. However, there is no requirement that the slot 16 should extend the full length of the tube section 14 so that the narrow section 19 could be provided by an unbroken part of the tubular section 14.

When the safety line 2 is used as part of a fall arrest system personnel will be linked to the safety line 2 by safety equipment including a safety line traveller which will move along the safety line 2 to follow the personnel as they move around the structure 3 but which will be able to respond to a fall event by gripping or locking to the safety line 2 in order to arrest the fall.

The tube 8 and the support arm 7 are shaped and profiled to cooperate with a safety line traveller so that a safety line traveller travelling along the safety line 2 can pass onto and over the tube 8 and the support arm 7.

Many different designs of safety line travellers able to pass along a safety line and automatically negotiate support arms or brackets supporting the safety line and the corresponding dimension, shapes and profiles of cooperating safety line supports and brackets are well known.

In the illustrated embodiment the support arm section 7 and tube 8 are shaped and arranged to cooperate with a safety line traveller of the “star wheel” type. However, it is believed that the invention is applicable to a system using any type of safety line traveller able to negotiate intermediate support arms or brackets and that the dimensions, shape and profile of the support arm 7 and cable securing section 6 should be selected to be suitable for cooperation with the safety line traveller to be used.

An example of a safety line traveller of the star wheel type is shown in FIGS. 6 and 7. The traveller comprises a pair of spaced apart coaxial wheels 300 formed with a series of radial arms 301 defining circumferential recesses 302 between them. The wheels 300 rotate on a single axle 304 and a circumferential slipper element 305 is mounted on the wheels 300, supported on the radial spokes 301 so that the wheels 300 are able to rotate relative to the slipper 306. A passage 307 through which the safety line 2 can pass is defined between the wheels 300, the axle 304 and the slipper element 305 and the tube 8 and swaged element 9 are sized and shaped to be able to pass through this passage 307.

As the traveller passes along the safety line 2 and onto the tube 8 and encounters the support arm 7 each of the multiple fingers 20 forming the support arm 7 adjacent to the tube 8 passes into a separate one of the circumferential recesses 302 and is able to pass between the axle 304 and the slipper 305, allowing the safety line traveller to pass over the support arm 7.

It should be noted that the number of fingers 20 is not an essential part of the invention but is simply selected based on the anticipated fall arrest loads, the material used for the support arm 7 and the size and spacing of the fingers 20 required in order to allow them to be traversed by the safety line traveller.

The separation of the cable securing section 6 from the tension adjusting section 5 must of course be sufficient to allow passage of the safety line traveller. However, it is generally desirable that the separation should be as low as possible in order to minimise the leverage applied to the bracket 4 by side loads along the safety line 2.

The swaged element 9 has an external screw thread 21 in its bottom end and a further section of safety line (not shown in the Figures) can be temporarily attached to the swaged element 9 by use of a threaded connector cooperating with the screw thread 21. The further section of safety line extends from the bottom anchor assembly 1 to ground level, or close to ground level. This allows the fall arrest protection provided by the height safety system incorporating the bottom anchor assembly 1 to extend all the way to ground level instead of stopping at the bottom anchor assembly which, as explained above, may be three or more metres above the ground.

In use personnel simply attach their safety line travellers to the extra section of safety line at ground level or any other convenient point, and ascend the structure 3. As the personnel pass the bottom anchor assembly 1 their safety line traveller 1 will pass over the tube 8 and support arm 7 and onto the safety line 2. The reverse procedure is followed by personnel descending the structure 3. As the personnel pass the bottom anchor assembly 1 their safety line traveller will move down the safety line 2 and traverse the tube 8 and support arm 7 onto the additional section of safety line extending below the bottom anchor assembly 1.

Thus, personnel can ascend and descend the structure 3 being fully protected against falls at all times and will only be required to attach themselves to a single height safety system on one occasion.

It should be noted that the personnel may attach themselves to the height safety system by attaching the dedicated safety line traveller to the safety line or alternatively, the safety line traveller may be retained on the safety line and personnel attach themselves to the height safety system by attaching personal safety equipment to the safety line traveller.

In order to allow smooth automatic movement of the safety line traveller on and off the tube 8 it is preferred that the upper end of the tube 8 have an inward taper. Further, in order to provide good contact between the tube 8 and the swaged element 9 it is preferred for the upper end of the swaged element 9 to have an inward taper and the lower end of the tube 8 to have a matching outward taper.

Use of a swaged element 9 to secure the safety line 2 relative to the tube 8 is not essential. Other forms of securing such a releasable clamp could be used if preferred.

In the preferred embodiment the swaged element 9 is attached to the end of the safety line 2 and the safety line 2 ends at the swaged element 9. A further safety line is then temporarily attached to the bottom of the swaged element 9. An alternative would be to have the safety line 2 pass through the tube 8 and the swaged element 9 or alternative clamping arrangement so that the safety line 2 extends both above and below the bottom anchor assembly 1 or to have the further safety line permanently attached to the swaged element 9. However, this will have the disadvantage that the section of safety line below the bottom anchor assembly cannot be removed while the safety line 2 is secured in place. It is advantageous to be able to remove the further safety line to prevent it being used to climb the structure by unauthorised persons while leaving the safety line 2 secured in place.

It is appreciated that when the further safety line is attached the bottom anchor assembly 1 will not strictly speaking be a bottom anchor for the safety line 2, but in most circumstances, the length of safety line 2 below the bottom anchor assembly 1 will be merely a few metres and thus very short compared to the length of the safety line 2 above the bottom anchor assembly. Further, the bottom anchor assembly 1 will be acting as a bottom anchor for the length of safety line 2 above the bottom anchor assembly 1.

The length of safety line below the bottom anchor assembly 1 will usually be relatively short and only a few metres. Accordingly, it is usually acceptable for this to hang free, although some retaining or supporting structure to prevent the free end of the safety line below the bottom anchor assembly 1 moving around excessively could be provided.

The tension indicator 18 is in the load path between the nut 11 and the bracket 4 so that the tension in the safety line 2 is applied to the tension indicator 18. Many suitable types of tension indicator are known and could be used in this invention.

The tension indicator shown in the Figures includes a wave spring and when the applied tension reaches a predetermined level the compression of the wave spring allows a coloured part of the tension indicator to be revealed so providing a visual indication that the desired tension has been reached. The central projection 22 at the top of the tension indicator 18 moves upwards when the wave spring is compressed revealing a brightly coloured surface which is concealed within the tension indicator 18 in the Figures.

The embodiments described above are examples only and the skilled person will be able to envisage other arrangements employing the invention.

1. A bottom anchor assembly for a substantially vertically-orientated elongate safety line, the anchor assembly comprising safety line gripping means, tensioning means for adjusting the safety line tension to a predetermined value, bracket means and connector arm means in which the tensioning means and safety line gripping means are spaced apart and are linked by the connector arm means.

2. A bottom anchor assembly according to claim 1, in which the safety line gripping means and the connector arm means are arranged to allow a safety line traveller moving along a safety line gripped by the safety line gripping means to pass over the safety line gripping means and the connector arm means.

3. A bottom anchor assembly according to claim 1, in which the safety line gripping means includes a swaged element attached at the end of the safety line.

4. A bottom anchor assembly according to claim 1, in which the safety line gripping means includes an attachment means for a further safety line to be releasably attached to the assembly.

5. A bottom anchor assemble according to claim 1, in which the safety line gripping means includes a swaged element attached at the end of the safety line and in which the attachment means comprises an external screw thread on the swaged element.

6. A bottom anchor assembly according to claim 1, in which the safety line gripping means comprises a tube through which the safety line passes.

7. A bottom anchor assembly according to claim 6, in which the connector arm is linked to the tube.

8. A bottom anchor assembly according to claim 6, in which the safety line gripping means includes a swaged element attached to the end of the safety line, in which the safety line gripping means also includes a tube through which the safety line passes, and in which the swaged element is attached to the safety line below the tube.

9. A bottom anchor assembly according to claim 1, in which the tensioning means comprises a rod having an externally threaded section and linked to the connector arm means and a nut on the externally threaded section, the nut being arranged to bear against a downwardly facing surface of the bracket.

10. A bottom anchor assembly according to claim 9, in which the bracket includes a tubular section and the rod is located at least partially within the tubular section.

11. A bottom anchor assembly according to claim 1, and further comprising indicator means for providing a visible indication of when said predetermined tension has been achieved.

12. (canceled)
